(19) United States
(12) Patent Application Publication
(10) Pub. No.: US 2003/0046166 A1
(43) Pub. Date: Mar. 6, 2003

(54) Automated self-service ordering system and method of use

(76) Inventor: Todd S. Liebman, Houston, TX (US)

Correspondence Address: Benjamin Aaron Adler, ADLER & ASSOCIATES, 8011 Candle Lane, Houston, TX, 77071, US

(21) Appl. No.: 09/883,043

(22) Filed: Jun. 15, 2001

(51) Int. Cl. G06F 17/60

(52) U.S. Cl. 705/15

(57) ABSTRACT

The present invention provides an automated touch-screen kiosks capable of receiving electronic payment in fast food restaurant for self-service customer ordering. The present kiosk system enhances customer satisfaction, lowers operation costs and increases sales and profits by facilitating easy use of credit card/debit card in the traditional cash only environment of fast food restaurant. Smart card reader can also be standard in the present touch-screen kiosk, thus enabling the application of smart card technology in fast food restaurant. The present system further promotes sales by giving customers suggestive sales appropriate to their orders through a rules-based software engine.

### BACKGROUND OF THE INVENTION

1. Field of the Invention

The present invention relates generally to electronic menu selection and ordering in a restaurant. More specifically, the present invention relates to an interactive self-service ordering system capable of receiving electronic payment and methods for its use in, e.g., a fast food restaurant.

2. Description of the Related Art

Retail stores, such as fast food restaurants and the like, have traditionally been labor intensive industries. In order to survive and gain a competitive edge in today's markets, there is a constant need in these businesses for tools and methods that maximize customer satisfaction and enhance profitability.

In a restaurant setting, such as a typical fast food restaurant, there is a need for a self service ordering system that let customers control the order process and reduces the customer's perceived wait time. The resulting improvement in the speed of service as well as order accuracy would increase customer satisfaction. Furthermore, an ordering system is desired that would lower the labor costs as well as generate increased sales and profit in the fast food restaurant. These objectives would be met by a system that encourages and facilitates the use of credit cards and other electronic payment in the fast food restaurant.

Several inventors have attempted unsuccessfully in the prior art to improve the service and profit in fast food restaurant. For example, Mueller et al., U.S. Pat. No. 5,235,509, teaches a self order system for a restaurant that allows a customer to order items via a computer terminal. Battistini et al., U.S. Pat. No. 6,087,927, discloses an order communication system for a restaurant in which menu items are displayed along with the cost. These two systems, however, do not provide the customer with the option of an electronic payment.

Camaisa et al., U.S. Pat. No. 5,845,263, discloses a restaurant ordering system in which a terminal displays menu items and related information such as nutritional information to the customer. The terminals have the ability to accept electronic payment. However, the terminals are set up at the customer's table in a non-fast food restaurant setting.

Lucero, U.S. Pat. No. Re34,872, discloses a drive through order entry system for a fast food restaurant in which menu items are displayed along with the cost. The customer uses a credit card to make an electronic payment at the order station. Once the order is placed and paid for, the user proceeds to a pickup station to receive the ordered food. However, Lucero's system lacks the capability to instant approve the electronic payment and debit the customer's account so that the assembly of the ordered food commences independent of the approval for the electronic payment.

Thus, the prior art is deficient in an automated ordering system that both improves customer satisfaction and increases profitability in fast food restaurant. The present invention fulfills this long-standing need and desire in the art.

### SUMMARY OF THE INVENTION

The present invention discloses an automated ordering system via user-friendly touch-screen kiosks in restaurants, such as fast food restaurants. Touch-screen instruments have been used in a number of business settings such as automated teller machines, E-ticketing for most major airlines and ticket purchasing at movie theater. The present invention utilizes this technology in a novel application in the fast food industry for enhancing customer satisfaction, lowering operation costs and increasing sales and profits. The touch-screen kiosk of the instant invention can be a freestanding kiosk inside the store (FIG. 1), a countertop model placed on the counter (FIG. 2), or an outdoor unit taking drive-through orders (FIG. 3).

Inaccuracy of customer orders has plagued fast food restaurants in the past. By utilizing a touch screen, customers can visualize their orders themselves prior to the kitchen receiving them. Confirmation of orders on the screen should reduce incorrect orders decreasing the amount of wasted food and therefore increasing profits for the restaurant. The touch-screen kiosk also increases the number of order points in the store and improves the customer's perception of “speed of service” by giving the restaurant crew a jump-start on orders. The food would be ready for the customer once the payment is completed at the front counter or at the kiosk.

The presently invented touch-screen kiosk system and methodology for its use also increases sales through automated suggestive selling. Customers ordering via the kiosk can receive a suggestive sale appropriate to their orders through a rules-based software engine. The suggestive selling feature will significantly increase store sales and profitability.

The present kiosk system further increases sales by facilitating easy use of credit cards in the traditional cash only environment of fast food restaurant. A credit/debit card reader is built into the touch-screen kiosk. This efficient process of accepting credit/debit cards will encourage customers currently not using credit cards to pay via these credit instruments. ATM/cash back feature can also be programmed into the present touch-screen kiosk system.

Smart cards or prepaid cards are useful instruments in the promotion of repeated business and brand loyalty. Smart card technology has been successfully implemented in applications such as video rental and prepaid telephone cards. The presently invented kiosk is equipped with a printer and is able to sell gift certificates or prepaid cards to customers in various denominations such as $5, $10 or $20. A smart card reader can be standard in the touch-screen kiosk of the instant invention, thus enabling the application of smart card technology in fast food restaurant.

Automated order entry process will lead to the elimination of one or more employees per shift, resulting in lowered operation and labor costs. The kiosk can handle peak load without the need for incremental staff, and improve transition during periods of low unemployment.

The present kiosk further provides an excellent source of additional revenue outside of fast food sales by advertising and cross promotions. Restaurant and advertiser have a captive audience while the customers are using the touch-screen kiosk of the present invention. Advertisements can be put either on the hardware portion of the kiosk itself, or on-screen through animation, verbal and/or video advertising. Each kiosk is equipped with a printer that prints a coupon on the backside of the receipt or alternatively, a pre-printed coupon on the backside of the receipt may be used. The coupons are redeemable for future visits, or are printed for cross-promotional ties with partners/advertisers.

In accordance with the above-mentioned teachings, in one embodiment of the present invention, there is provided a method of self-service ordering at a restaurant, comprising the steps of: (a) providing a kiosk at a first location in said restaurant, said kiosk comprising a touch-sensitive screen panel and receiving means for receiving and transmitting information stored on a patron's charge card instrument; (b) operating said touch-screen panel by a patron to order at least one item; (c) totaling the charges for said at least one item ordered by said patron; (d) inserting a patron's charge card instrument into said receiving means on said kiosk; (e) verifying the patron's account represented by said charge card instrument and approving the information stored on the patron's charge card instrument; (f) debiting the patron's account in the amount of said totaled charges; and (g) assembling said at least one item at a second location remote from said first location using order information collected on said touch-screen panel and delivering said item to the patron at a location remote from said first location at which said kiosk is located.

The present invention also provides a self-service ordering system capable of receiving electronic payment at a restaurant, the system comprising: a kiosk displayed at a first location in said restaurant, said kiosk comprising a touch-screen panel upon which a patron can select and order at least one item; means for communicating said patron's order to a second location remote from said first location in said restaurant, wherein said item ordered by said patron is assembled at said second location; and means on said kiosk for receiving and transmitting information stored on said patron's charge card instrument for accessing said patron's account represented by said charge card instrument and debiting said account for the total charge for the item ordered by said patron.

In another aspect, the present invention relates to a method of self-service ordering at a restaurant, comprising the steps of: (a) providing a kiosk at a first location in said restaurant, said kiosk comprising a touch-screen panel and a receiving means for receiving and transmitting information stored on a patron's payment instrument; (b) operating at said touch-screen panel by a patron to order at least one item, said operating comprising verbalizing the name of said item to said kiosk; (c) totaling the charges for said at least one item ordered by said patron; (d) inserting a patron's payment instrument into said receiving means on said kiosk; (e) verifying the patron's account represented by said payment instrument and approving the information stored on the patron's payment instrument; (f) debiting the patron's account in the amount of said totaled charges; and (g) assembling said at least one item at a second location remote from said first location using order information collected on said touch-screen panel and delivering said item to the patron at a location remote from said first location at which said kiosk is located.

The present invention further provides a method of self-service ordering at a restaurant, comprising the steps of: (a) providing a kiosk at a first location in said restaurant, said kiosk comprising a touch-screen panel and a receiving means for receiving and transmitting information stored on a patron's payment instrument; (b) operating at said touch-screen panel by a patron to order at least one item; (c) totaling the charges for said at least one item ordered by said patron; (d) inserting a patron's payment instrument into said receiving means on said kiosk; (e) verifying the patron's account represented by said payment instrument and approving the information stored on the patron's payment instrument; (f) receiving said patron's electronic signature as an acceptance of said totaled charges for the food item ordered by said patron; (g) debiting the patron's account in the amount of said totaled charges; and (h) assembling said at least one item at a second location remote from said first location using order information collected on said touch-screen panel and delivering said item to the patron at a location remote from said first location at which said kiosk is located.

Other and further aspects, features, and advantages of the present invention will be apparent from the following description of the presently preferred embodiments of the invention. These embodiments are given for the purpose of disclosure.

### BRIEF DESCRIPTION OF THE DRAWINGS

So that the matter in which the above-recited features, advantages and objects of the invention as well as others which will become clear are attained and can be understood in detail, more particular descriptions and certain embodiments of the invention briefly summarized above are illustrated in the appended drawings. These drawings form a part of the specification. It is to be noted, however, that the appended drawings illustrate preferred embodiments of the invention and therefore are not to be considered limiting in their scope.

FIG. 1 shows one embodiment of a freestanding touch-screen ordering kiosk in fast food restaurant.

FIG. 2 shows one embodiment of a countertop model of the kiosk.

FIG. 3 shows one embodiment of an outdoor kiosk for drive-through ordering.

FIG. 4 shows a perspective view of one embodiment of a freestanding touch-screen ordering kiosk.

FIG. 5 shows a flow chart for the order process using the touch-screen ordering kiosk of the instant invention.

FIG. 6 shows one embodiment of touch-screen display on the ordering kiosk. FIG. 6A shows a screen display for ordering various food items such as combination meal, drink, and fries. FIG. 6B shows a screen for customizing a patron's selection. FIG. 6C shows a screen for suggesting a dessert order to the patron. FIG. 6D shows a screen for the patron to choose a payment method.

FIG. 7 shows a flow chart for payment by cash, credit card or debit card.

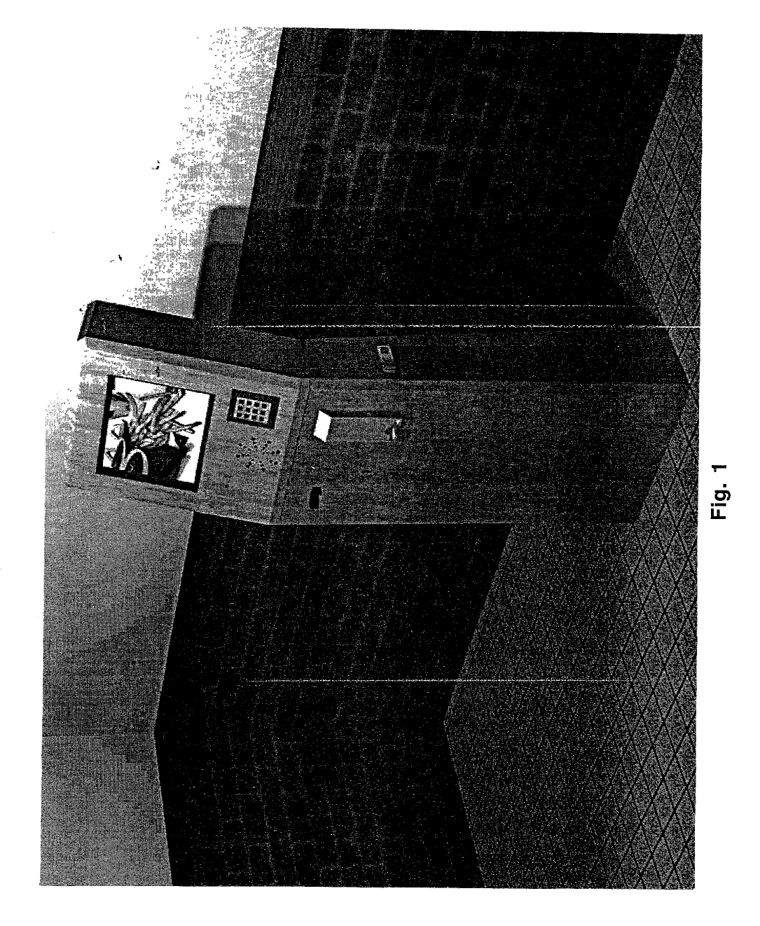

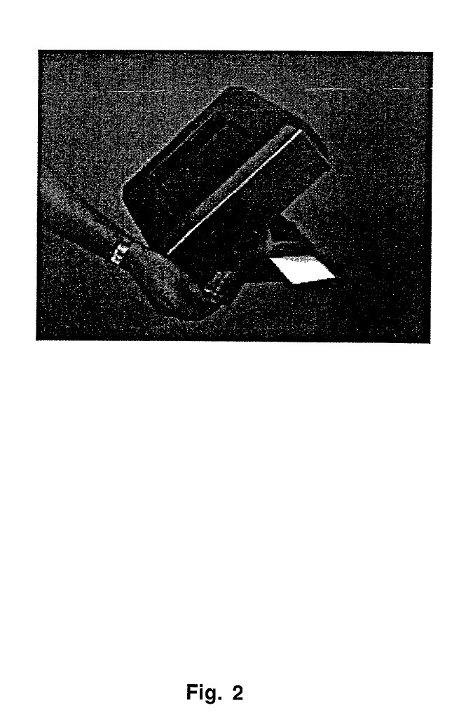

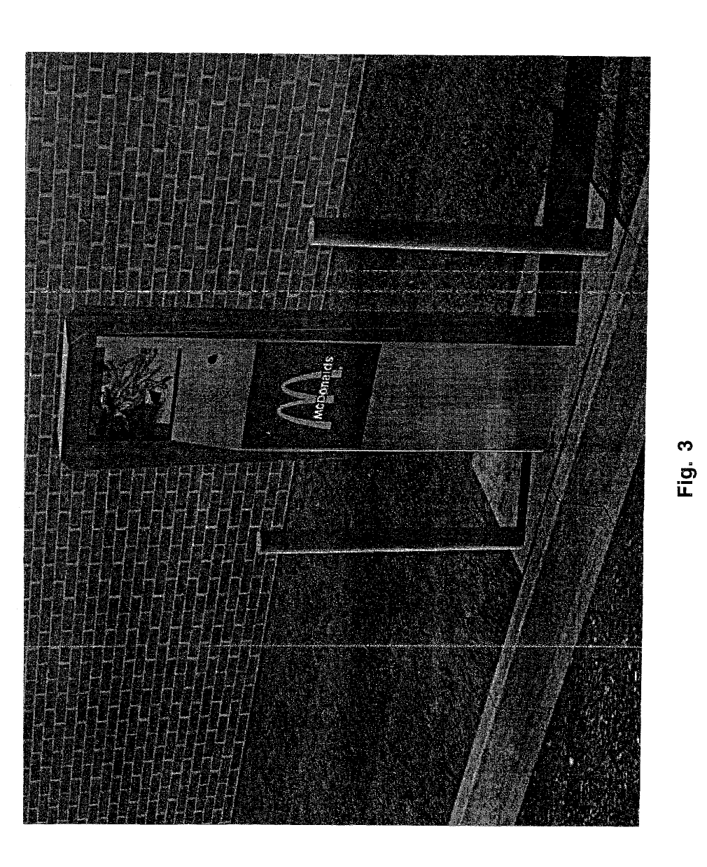

### DETAILED DESCRIPTION OF THE INVENTION

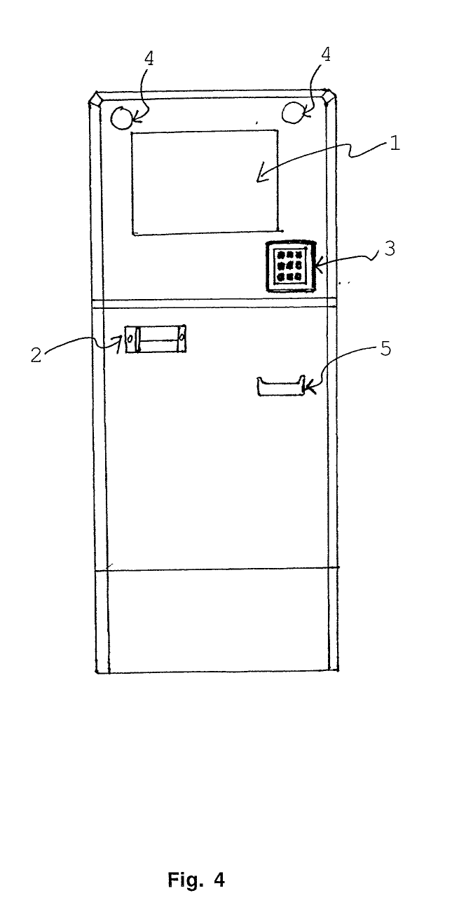

The present invention provides a method of self-service ordering at a restaurant, such as a fast food restaurant, using an automated touch-screen kiosk. In general, a freestanding ordering kiosk has a touch-screen panel 1 and a card reader 2 capable of reading a patron's payment card (credit card, debit card, smart card, a gift card etc.) (FIG. 4). The kiosk also has a PIN pad 3 for PIN verification in a ATM/cash back transaction. A speaker 4 on the kiosk provides audio capability during the ordering process, and a printer inside the kiosk will print out a receipt to be picked up by the patron at the receipt pick-up point 5.

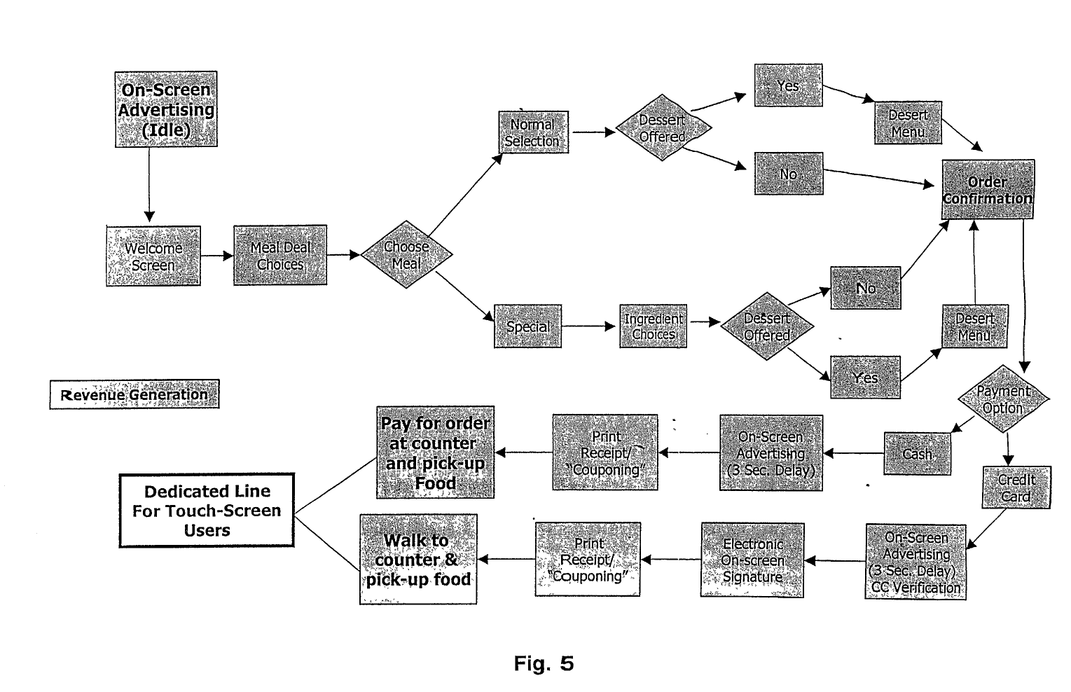

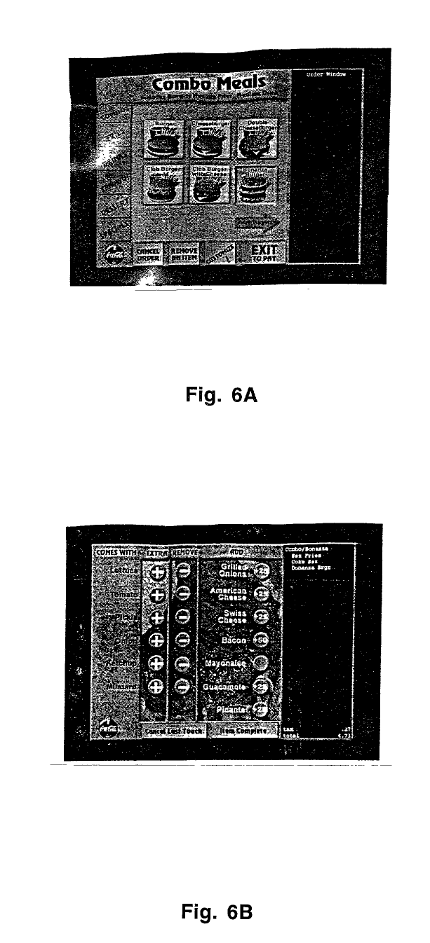

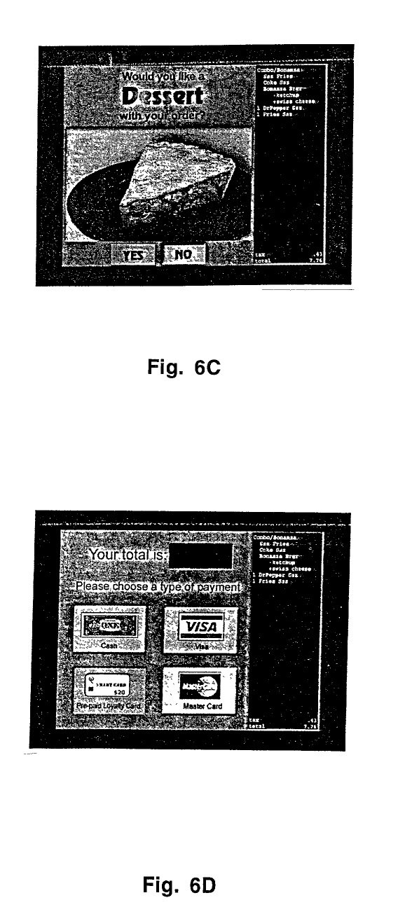

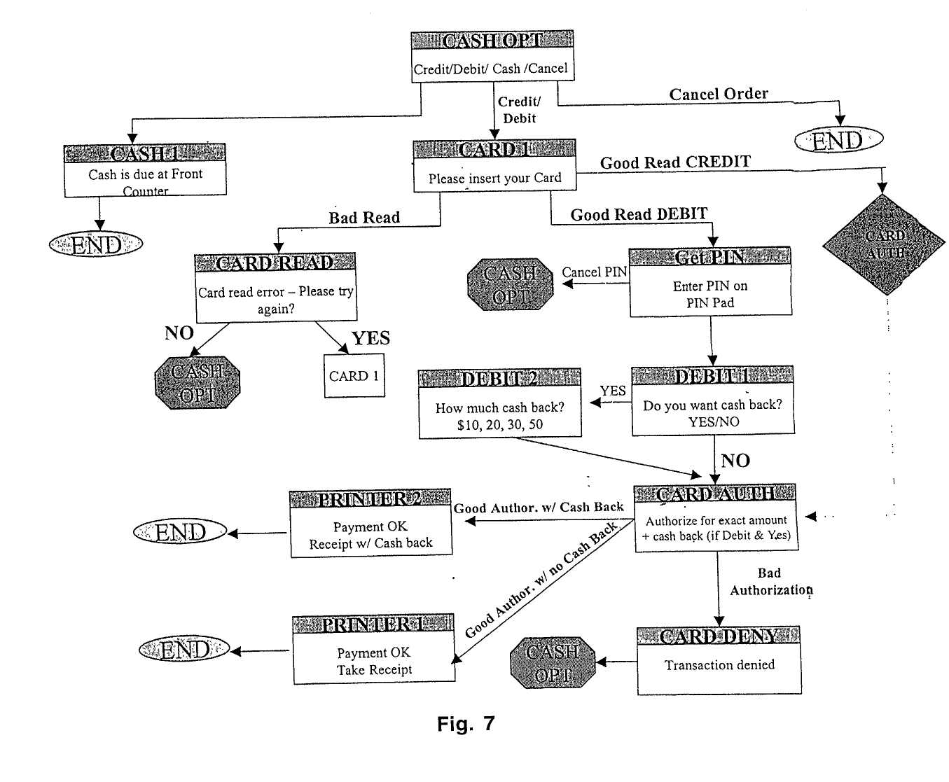

The order process is initiated by a patron making a selection on the touch-screen panel (FIG. 5-6), and the ordering scheme is applicable to both ordering in-store as well as ordering at the drive-through lanes. A patron selects various items, e.g., a combination meal, a drink, and fries or other items such as toys, gifts, newspapers, etc by touching the corresponding symbols or buttons on the screen (FIG. 6A). A patron can further customize the selection by adding or removing specific ingredients of his/her choice from the selected food items (FIG. 6B). A list of items selected by the patron together with the total charges for the selected items will be displayed on the screen as the patron goes through the ordering process. At the end of the selection process, a screen will come up to suggest a dessert order to the patron (FIG. 6C). Suggestion of additional items for sale that are appropriate to the items ordered by the patron can also be provided throughout the ordering process. For example, if a customer orders a hamburger and french fries without a drink, the kiosk of the present invention will provide a suggestion to the customer by audio and/or visual display to order a drink.

After the order is confirmed by the patron, the patron can choose to pay by any of a variety of payment instruments known in the art, e.g., cash, credit card or prepaid/smart card (FIG. 6D, 7). If the patron wants to pay by cash, a receipt will be printed out and audio command from the kiosk will tell the customer what to do next. Usually the patron will go to the front counter or other designated area to pay for and pick up the food or other items. If the patron chooses electronic payment, he/she then inserts a credit card, debit card or prepaid, a gift card or smart card into the card reader of the kiosk. For debit card and cash back transaction, the patron can enter his/her personal identification number (PIN) on the PIN pad. After authorization is received for the electronic payment, a receipt is printed out for the patron to keep for as a record. The customer then proceeds to the front counter or other designated area to pick up the ordered food. In another embodiment of the instant invention, the patron may authorize an electronic payment by providing a signature in a paperless, electronic format, i.e, the customer “signs” an authorization electronically using a “pen” useful only for such an electronic signature and the customer “signs” an authorization on an electronic signature strip designated for such use.

In one aspect of the present invention, for use in credit transactions, a commercial software product (PC Charge from CD3 Software) was purchased and integrated. A 10 BaseT local area network was used to send files that have the pertinent credit card information (information taken from either track 1, 2, and/or 3) such as the amount of the transaction, name of the individual, expiration date, etc. back to a computer, e.g., laptop, in the back office of the restaurant establishment. The computer is dedicated for credit card processing only and has the PC Charge program loaded onto it. An input file is sent via a LAN to a specific directory on the laptop where the PC Charge program picks up the file, dials out and attempts to verify the card in question. Once it receives back the information about the card from the processor, an output file is left in the same directory where it is then picked back up by the program and sent back to the kiosk over a LAN and either prints a receipt (meaning that it was a good transaction) or denies the transaction and tells the customer to choose another payment method.

Audio functions that assist and/or direct customers in the ordering process can be integrated into the kiosk and methods of the instant invention. Greetings to customer can be transmitted through the speaker on the kiosk at the beginning of the ordering process. The speaker on the kiosk also allows voice instruction and communication to be provided throughout the ordering process to offer help, guide, suggest and/or confirm the patron's selection. Moreover, in another embodiment of the present invention, voice recognition technology can be built into or supplied with the kiosk so that the customer can order and select items by pronouncing the names of the items, such as food items, during ordering by verbalizing a command, as well as responding using the customer's voice to questions displayed as text on the touch-screen of the kiosk of the present invention.

Thus, in one aspect of the present invention, there is provided a method of self-service ordering which is applicable to both in-store transaction at a restaurant and an outdoor transaction at drive through feature of the restaurant. This method involves operation by or for a patron alone who orders one or more items at a kiosk located at a first location in the restaurant. The kiosk comprises a touch-screen panel and receiving means such as a card reader for receiving and transmitting information stored on the patron's charge card instrument such as a credit card, debit card, a gift card or prepaid/smart card. Advertisements can be displayed on the ordering kiosk, e.g. on the touch-screen panel. The charges for all the ordered items are totaled and the patron can insert a payment instrument, such as a charge card, into the card reader on the kiosk. The patron's account represented by the payment instrument is verified, approved and an amount equal to the totaled charges for the ordered items is debited from the patron's account. After the ordered items are assembled at a second location remote from the first location using order information collected on the touch-screen panel of the kiosk, the items are delivered for pickup by the patron at a location remote from the first location where the kiosk is located.

In one embodiment of the presently described methodology, the patron can order items by pronouncing the names of the food items to the kiosk due to a voice recognition capability on the kiosk. In another embodiment, the ordering process further includes a step of suggesting to the patron additional items for sale that are appropriate to the items ordered by the patron. This suggestive selling can be delivered by audio and/or video display on the kiosk.

In yet another embodiment of the present method, the ordering process further includes a step of printing out a receipt that at least includes the total charge for the items ordered. A coupon can also be included on the printed receipt. In one embodiment, the patron can provide payment or accept the charge on his/her charge account by providing a signature in a paperless, electronic format.

In another aspect of the present invention, there is provided a self-service ordering system capable of receiving electronic payment at a restaurant, the system comprises of a kiosk having a touch-screen panel displayed at a first location in the restaurant. Patrons select and order items on the touch-screen panel. The system further includes means for communicating the patron's order to a second location where the ordered items are assembled; and means on the kiosk for receiving and transmitting information stored on the patron's charge card instrument for accessing the patron's account and debiting the total charge for the ordered items from the account. In general, the payment instrument is a credit card, debit card, a gift card (for example, a gift card that can be re-charged using a credit card and used or provided to someone such as a child as a gift) or a prepaid/smart card.

In one embodiment of the present invention, the self-service ordering system further includes a means for generating a printed receipt that at least includes the total charge for the ordered items and a designated portion for receiving the patron's signature in accepting the charge on the patron's account. A coupon can also be included on the printed receipt. In another embodiment, the system can include a means for receiving the patron's signature in a paperless, electronic format. In yet another embodiment, the present system further comprises means for transmitting and producing audio signals that provide audio information in assisting and directing a patron in the ordering process. Moreover, means of voice recognition for receiving and responding to order articulated and verbalized by a patron can also be included in the system of the present invention.

The present examples, along with the methods and procedures described herein are presently representative of preferred embodiments, are exemplary, and are not intended as limitations on the scope of the invention. One skilled in the art will appreciate readily that the present invention is well adapted to carry out the objects and obtain the ends and advantages mentioned, as well as those objects, ends and advantages inherent herein. Changes therein and other uses will occur to those skilled in the art which are encompassed within the spirit of the invention as defined by the scope of the claims.

What is claimed is:

1. A method of self-service ordering at a restaurant, comprising the steps of:
(a) providing a kiosk at a first location in said restaurant, said kiosk comprising a touch-screen panel and a receiving means for receiving and transmitting information stored on a patron's payment instrument;
(b) operating at said touch-screen panel by a patron to order at least one item;
(c) totaling the charges for said at least one item ordered by said patron;
(d) inserting a patron's payment instrument into said receiving means on said kiosk;
(e) verifying the patron's account represented by said payment instrument and approving the information stored on the patron's payment instrument;
(f) debiting the patron's account in the amount of said totaled charges; and
(g) assembling said at least one item at a second location remote from said first location using order information collected on said touch-screen panel and delivering said item to the patron at a location remote from said first location at which said kiosk is located.

2. The method of claim 1, wherein said payment instrument is selected from the group consisting of a charge card, a credit card, a debit card, a gift card and a smart card.

3. The method of claim 1, wherein advertisements are displayed on said touch-screen panel of said kiosk.

4. The method of claim 1, further comprising a step after step (f) of printing out a receipt wherein said receipt contains the total charge for the items ordered by said patron and a designated location.

5. The method of claim 4, wherein a coupon is printed on said receipt.

6. The method of claim 1, wherein said kiosk is located at a drive through location of said restaurant.

7. The method of claim 1, wherein said item is a food item, a toy, or a newspaper.

8. A method of self-service ordering at a restaurant, comprising the steps of:
(a) providing a kiosk at a first location in said restaurant, said kiosk comprising a touch-screen panel and a receiving means for receiving and transmitting information stored on a patron's payment instrument;
(b) operating at said touch-screen panel by a patron to order at least one item;
(c) suggesting to said patron additional items for sale that are appropriate to the items ordered by said patron, wherein said suggesting is delivered by a mean selected from the group consisting of a video display, an audio display and an audio-visual display.
(d) totaling the charges for said at least one item ordered by said patron;
(e) inserting a patron's payment instrument into said receiving means on said kiosk;
(f) verifying the patron's account represented by said payment instrument and approving the information stored on the patron's payment instrument;
(g) debiting the patron's account in the amount of said totaled charges; and
(h) assembling said at least one item at a second location remote from said first location using order information collected on said touch-screen panel and delivering said item to the patron at a location remote from said first location at which said kiosk is located.

9. The method of claim 8, wherein said payment instrument is selected from the group consisting of a charge card, a credit card, a debit card, a gift card and a smart card.

10. The method of claim 8, wherein advertisements are displayed on said touch-screen panel on said kiosk.

11. The method of claim 8, further comprising a step after step (g) of printing out a receipt wherein said receipt contains the total charge for the items ordered by said patron and a designated location.

12. The method of claim 11, wherein a coupon is printed on said receipt.

13. The method of claim 8, wherein said kiosk is located at a drive through location of said restaurant.

14. The method of claim 8, wherein said item is a food item, a toy, or a newspaper.

15. A method of self-service ordering at a restaurant, comprising the steps of:
(a) providing a kiosk at a first location in said restaurant, said kiosk comprising a touch-screen panel and a receiving means for receiving and transmitting information stored on a patron's payment instrument;
(b) operating at said touch-screen panel by a patron to order at least one item, said operating comprising verbalizing the name of said item to said kiosk;
(c) totaling the charges for said at least one item ordered by said patron;
(d) inserting a patron's payment instrument into said receiving means on said kiosk;
(e) verifying the patron's account represented by said payment instrument and approving the information stored on the patron's payment instrument;
(f) debiting the patron's account in the amount of said totaled charges; and
(g) assembling said at least one item at a second location remote from said first location using order information collected on said touch-screen panel and delivering said item to the patron at a location remote from said first location at which said kiosk is located.

16. The method of claim 15, wherein said payment instrument is selected from the group consisting of a charge card, a credit card, a debit card, a gift card and a smart card.

17. The method of claim 15, wherein advertisements are displayed on said touch-screen panel on said kiosk.

18. The method of claim 15, further comprising a step after step (f) of printing out a receipt wherein said receipt contains the total charge for the items ordered by said patron and a designated location for receiving said patron's signature in accepting said charge on said patron's account.

19. The method of claim 18, wherein a coupon is printed on said receipt.

20. The method of claim 15, wherein said kiosk is located at a drive through location of said restaurant.

21. The method of claim 15, wherein said item is a food item, a toy, or a newspaper.

22. A method of self-service ordering at a restaurant, comprising the steps of:
(a) providing a kiosk at a first location in said restaurant, said kiosk comprising a touch-screen panel and a receiving means for receiving and transmitting information stored on a patron's payment instrument;
(b) operating at said touch-screen panel by a patron to order at least one item;
(c) totaling the charges for said at least one item ordered by said patron;
(d) inserting a patron's payment instrument into said receiving means on said kiosk;
(e) verifying the patron's account represented by said payment instrument and approving the information stored on the patron's payment instrument;
(f) receiving said patron's electronic signature as an acceptance of said totaled charges for the food item ordered by said patron;
(g) debiting the patron's account in the amount of said totaled charges; and
(h) assembling said at least one item at a second location remote from said first location using order information collected on said touch-screen panel and delivering said item to the patron at a location remote from said first location at which said kiosk is located.

23. The method of claim 22, wherein said payment instrument is selected from the group consisting of a charge card, a credit card, a debit card, a gift card and a smart card.

24. The method of claim 22, wherein advertisements are displayed on said touch-screen panel on said kiosk.

25. The method of claim 2, wherein said kiosk is located at a drive through location of said restaurant.

26. A self-service ordering system capable of receiving electronic payment at a restaurant, the system comprising:
a kiosk displayed at a first location in said restaurant, said kiosk comprising a touch-screen panel upon which a patron can select and order at least one item;
means for communicating said patron's order to a second location remote from said first location in said restaurant, wherein said item ordered by said patron is assembled at said second location; and
means on said kiosk for receiving and transmitting information stored on said patron's payment instrument for accessing said patron's account represented by said payment instrument and debiting said account the total charge for the item ordered by said patron.

27. The system of claim 26, wherein said payment instrument is selected from the group consisting of a charge card, a credit card, a debit card, a gift card and a smart card.

28. The system of claim 26, further comprising a means for generating a printed receipt wherein said receipt contains the total charge for the item ordered by said patron and a designated portion for receiving said patron's signature in accepting said charge on said patron's account.

29. The system of claim 28, wherein a coupon is printed on said receipt.

30. The system of claim 26, further comprising a means for receiving said patron's electronic signature in accepting said total charge for the food item ordered by said patron.

31. The system of claim 26, further comprising a means for transmitting and producing audio signals that provide audio information in assisting and directing a patron in the ordering process.

32. The system of claim 26, further comprising a means for receiving and responding to order articulated and verbalized by said patron, said order comprising names of the food items ordered by said patron.

33. The method of claim 36, wherein said item is a food item, a toy, or a newspaper.
